(19) United States
(12) Patent Application Publication
(10) Pub. No.: US 2026/0213992 A1
(43) Pub. Date: Jul. 23, 2026

(54) PHASE COMPENSATION FOR MULTICARRIER SIGNALING

(71) Applicant: Murata Manufacturing Co., Ltd, Nagaokakyo-shi, Kyoto (JP)

(72) Inventors: Pushp TRIKHA, San Diego, CA (US); Peter BACON, Derry, NH (US)

(21) Appl. No.: 19/127,026

(22) PCT Filed: Nov. 2, 2023
(86) PCT No.: PCT/US2023/078504

§ 371 Date: May 2, 2025

Related U.S. Application Data
(60) Provisional application No. 63/382,579, filed on Nov. 7, 2022.

(51) Int. Cl. H04L 27/26; H04L 5/00

(52) U.S. Cl. CPC H04L 27/2657; H04L 5/001

(57) ABSTRACT

Disclosed is an apparatus and a method for phase compensation in multicarrier communication. The method includes identifying, from a plurality of component carriers, a first component carrier having a first boundary and a second component carrier having a second boundary; obtaining a gain state phase at the first boundary of the first component carrier; and performing a phase compensation for the second component carrier based on the gain state phase of the first component carrier.

### REFERENCE TO CROSS-RELATED APPLICATIONS

The present application claims priority to U.S. Patent Application No. 63/382,579 filed on Nov. 7, 2022, the contents of which are incorporated herein by reference in its entirety.

### FIELD

The present disclosure relates generally to phase compensation, and more particularly, to methods and apparatuses for phase compensation for multicarrier signaling in wireless communication.

### BACKGROUND

In some multicarrier signaling system, for example, a user equipment (UE) receiving downlink (DL) multiple carriers from two base stations that are not collocated, the propagation delay of the multiple carriers at the UE may cause phase transient due to gain stage change. This may deteriorate the quality of the received signal.

### SUMMARY

According to some embodiments of the present disclosure, there is provided a method for phase compensation in a multicarrier communication. The method includes: identifying, from a plurality of component carriers, a first component carrier having a first boundary and a second component carrier having a second boundary; obtaining a gain state phase at the first boundary of the first component carrier; and performing a phase compensation for the second component carrier based on the gain state phase of the first component carrier.

According to some embodiments of the present disclosure, there is provided a mobile device for wireless communication. The mobile device includes: at least one antenna, a processor, and a memory storing instructions. The instructions, when executed by the processor, cause the mobile device to: receive a signal comprising a first component carrier and a second component carrier, the first component carrier including a first boundary and the second component carrier including a second boundary; obtain a gain state phase at the first boundary of the first component carrier; and perform a phase compensation for the second component carrier based on the gain state phase of the first component carrier.

According to some embodiments of the present disclosure, there is further provided a non-transitory computer-readable medium having stored therein instructions that, when executed by a processor, perform a method for phase compensation. The method includes identifying, from a plurality of component carriers, a first component carrier having a first boundary and a second component carrier having a second boundary; obtaining a gain state phase at the first boundary of the first component carrier; and performing a phase compensation for the second component carrier based on the gain state phase of the first component carrier.

### BRIEF DESCRIPTION OF FIGURES

FIG. 1 is a schematic diagram illustrating a wireless communication system 100, consistent with some embodiments of the present disclosure.

FIG. 2A is a schematic diagram illustrating a difference of signal level of DL carriers received by a UE in a wireless communication system; and FIG. 2B is a schematic diagram illustrating a difference of arrival times of DL carriers at the UE in the wireless communication system.

FIG. 3 is a schematic diagram illustrating a wireless communication system 300, consistent with some embodiments of the present disclosure.

FIG. 4A is a schematic diagram illustrating a difference of signal level of DL carriers received by a UE in a wireless communication system; and FIG. 4B is a schematic diagram illustrating a difference of arrival times of DL carriers at the UE in the wireless communication system.

FIG. 5 is a schematic diagram illustrating a front end of a receiver circuit in a UE implementing a two by two (2×2) MIMO communication.

FIG. 6 is a schematic diagram illustrating a front end of a receiver circuit in a UE implementing a four-by-four (4×4) MIMO communication.

FIG. 7 is a schematic diagram illustrating phase compensation in a front-end of a receiver circuit 700 of a UE, consistent with some embodiments of the present disclosure.

FIG. 8 is a schematic diagram illustrating an exemplary phase compensation measurement platform 800, consistent with some embodiments of the present disclosure.

FIG. 9 is a plot illustrating measured settling of the gain phase of a received signal, consistent with some embodiments of the present disclosure.

FIG. 10 is a plot illustrating measured settling of the gain amplitude of a received signal, consistent with some embodiments of the present disclosure.

FIG. 11 is a schematic drawing illustrating the parameters used in the simulation, consistent with some embodiments of the present disclosure.

FIG. 12A is a plot illustrating a simulated frequency-domain normalized power spectral density of an input signal; FIG. 12B is a plot illustrating a simulated frequency-domain normalized power spectral density of the signal having transient in the cyclic prefix (CP) of the symbol; FIG. 12C is a plot illustrating a simulated frequency-domain normalized power spectral density of the signal having transient in the middle of the symbol; and FIG. 12D is a plot illustrating a simulated frequency-domain normalized power spectral density of the signal having transient compensated, consistent with some embodiments of the present disclosure.

FIG. 13A is a plot illustrating a simulated symbol error vector magnitude (EVM) of an input signal; FIG. 13B is a plot illustrating a simulated symbol EVM of the signal having transient in the CP of the symbol; FIG. 13C is a plot illustrating a simulated symbol EVM of the signal having transient in the middle of the symbol; and FIG. 13D is a plot illustrating a simulated symbol EVM of the signal having transient compensated, consistent with some embodiments of the present disclosure.

FIG. 14A is a diagram illustrating constellation of an input signal; FIG. 14B is a diagram illustrating constellation of the signal having transient in the CP of the symbol;

FIG. 14C is a diagram illustrating constellation of the signal having transient in the middle of the symbol; and FIG. 14D is a diagram illustrating constellation of the signal having transient compensated, consistent with some embodiments of the present disclosure.

FIG. 15A is a plot illustrating a simulated complimentary cumulative density function (CCDF) of an input signal; FIG. 15B is a plot illustrating a simulated CCDF of the signal having transient in the CP of the symbol; FIG. 15C is a plot illustrating a simulated CCDF of the signal having transient in the middle of the symbol; and FIG. 15D is a plot illustrating a simulated CCDF of the signal having transient compensated, consistent with some embodiments of the present disclosure.

FIG. 16 is a block diagram illustrating an exemplary device 1600, consistent with some embodiments of the present disclosure.

FIG. 17 is a flow chart illustrating a method 1700 for phase compensation in multicarrier communication, consistent with some embodiments of the present disclosure.

FIG. 18 is a flow chart illustrating a method 1800 for characterizing a phase transient in carrier components, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

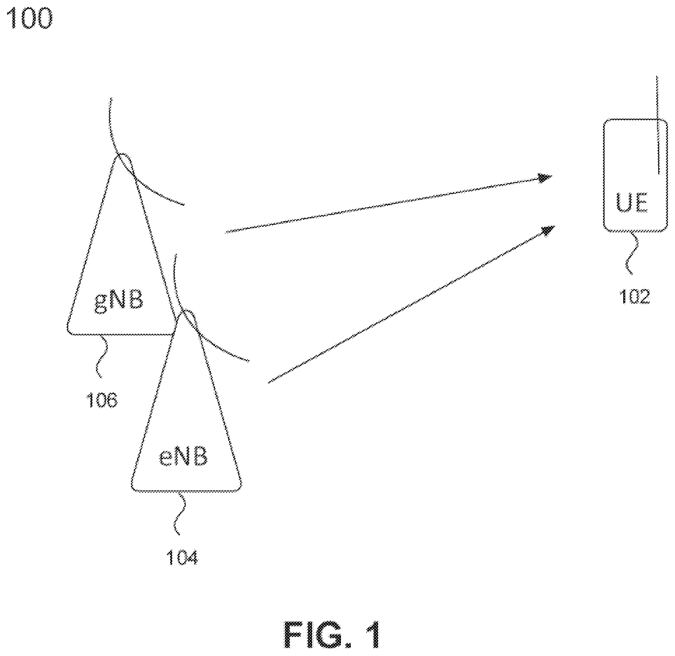

FIG. 1 is a schematic diagram illustrating a wireless communication system 100, consistent with some embodiments of the present disclosure. Referring to FIG. 1, the wireless communication system 100 includes a UE 102, an evolved nodeB (eNB) 104 for the fourth generation (4G) network, and a gNodeB (gNB) 106 for the fifth generation (5G) network. The UE 102 may have dual connectivity to the eNB 104 and the gNB 106. The eNB 104 may transmit DL signals to UE 102 through a first carrier having a first frequency. The gNB 106 may transmit DL signals to UE 102 through a second carrier having a second frequency different from the first frequency. The UE 102 may transmit uplink signals to the eNB 104 and the gNB 106. The eNB 104 and the gNB 106 are collocated.

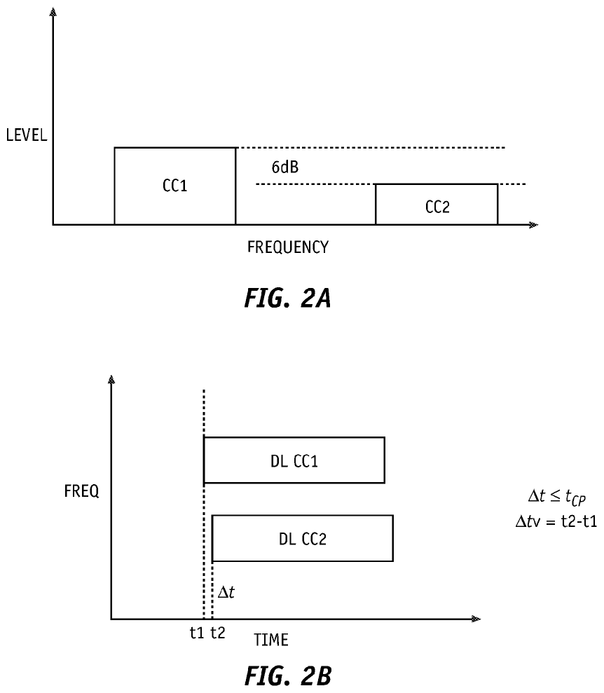

FIG. 2A is a schematic diagram illustrating a difference of signal level of the DL carriers received by the UE 102 in the wireless communication system 100 (FIG. 1) Referring to FIG. 2A, the carrier component 1 (CC1) may be the DL carrier received from eNB 104 and the carrier component 2 (CC2) may be the DL carrier received from gNB 106. As shown in FIG. 2A, the difference of the signal levels of the DL CC1 and the DL CC2 may not be significant. In some cases, the difference of the signal levels of the CC1 and the CC2 may be less than 10 dB, for example, 6 dB as shown in FIG. 2A.

FIG. 2B is a schematic diagram illustrating a difference of arrival times of DL carriers at the UE 102 in the wireless communication system 100 (FIG. 1). Referring to FIG. 2B, the DL CC 2 transmitted from gNB 106 may arrive at the UE 102 at t2 and the DL CC1 may arrive at the UE 102 at t1. Since the eNB 104 and the gNB 106 are collocated, the difference between t1 and t2 (i.e., the propagation delay between the DL CC1 and DL CC2 indicated as Δt in FIG. 2B) may be very small and thus negligible. For example, the difference between t1 and t2 may be less than 3 microseconds (μs) or less than a length of a CP (t_{CP}). The UE having dual connectivity with such collocated base stations is called “type 1 UE” hereinafter. In a type 1 UE, since the propagation delay is smaller than a usual length of a CP (e.g., around 7% of an orthogonal frequency-division multiplexing (OFDM) length), the phase transient caused by the gain state change at a beginning of a symbol may be confined within a CP of the symbol and can be effectively eliminated by the CP. A CP represents a guard period at the start of each OFDM symbol and provides protection against phase transient.

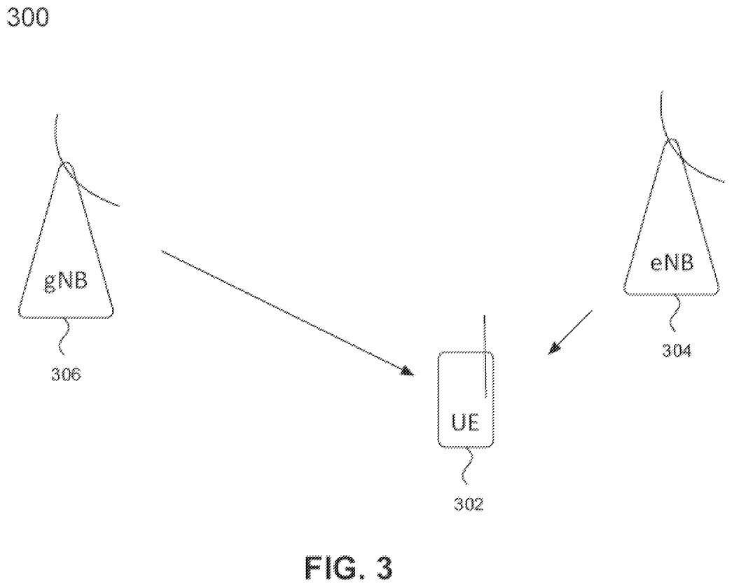

FIG. 3 is a schematic diagram illustrating a wireless communication system 300, consistent with some embodiments of the present disclosure. Referring to FIG. 3, the wireless communication system 300 includes a UE 302, an eNB 304, and a gNB 306. The UE 302 may have dual connectivity to the eNB 304 and the gNB 306. The eNB 304 may transmit DL signals to UE 302 through a first carrier with a first frequency. The gNB 306 may transmit DL signals to UE 302 through a second carrier having a second frequency different from the first frequency. The UE 302 may transmit uplink signals to the eNB 304 and the gNB 306. Compared with the communication system 100 in FIG. 1, in the communication system 300, the eNB 104 and the gNB 106 are located at two separate positions (i.e., non-collocated).

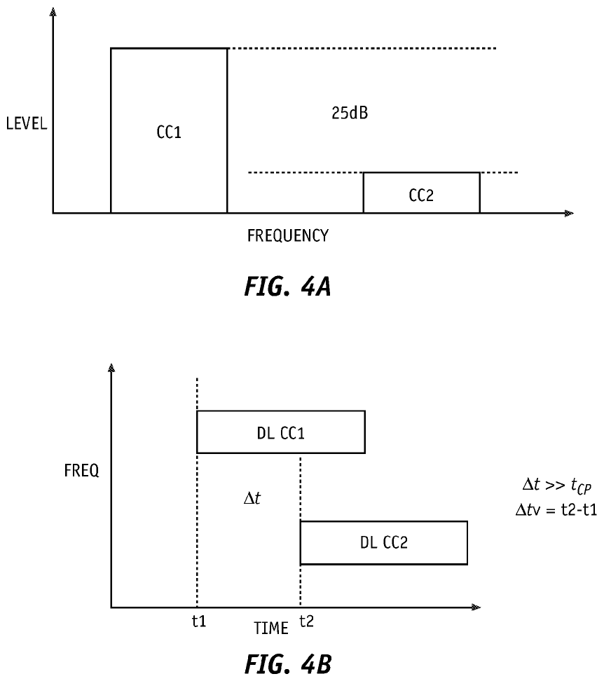

FIG. 4A is a schematic diagram illustrating a difference of signal level of the DL carriers received by the UE 302 in the wireless communication system 300 (FIG. 3). Referring to FIG. 4A, a difference of the signal levels of the CC1 and the CC2 may be significant. In some cases, the difference of the signal levels of the CC1 and the CC2 can be around 25 dB as shown in FIG. 4A.

FIG. 4B is a schematic diagram illustrating a difference of arrival times of DL carriers at the UE 302 in the wireless communication system 300 (FIG. 3). Referring to FIG. 4A, the DL CC 2 transmitted from gNB 306 may arrive at the UE 302 at t2 and the DL CC1 transmitted from eNB 304 may arrive at the UE 302 at t1. Since the eNB 304 and the gNB 306 are non-collocated, the difference between t1 and t2 (indicated as Δt in FIG. 4B) may be significant. For example, the difference between t1 and t2 may be around 33 μs or much larger than a length of a CP (t_{CP}). The UE having dual connectivity with such non-collocated base stations is called “type 2 UE” hereinafter. In a type 2 UE, since the delay (e.g., around 33 μs) is much larger than a length of the CP and cannot be confined within the CP, the effect of the phase transient due to the gain state change cannot be eliminated by the CP.

In some embodiments, the type 2 UE may implement a two-by-two (2×2) multiple-input and multiple-output (MIMO) communication, and the phase transient may be mitigated by using a separate automatic gain controller (AGC) in each signal chain for the DL CC1 and DL CC2, as discussed below. A MIMO order refers to a number of separate data streams sent or received. For instance, MIMO order for DL communications can be described by a number of transmit antennas of a base station and a number of receive antennas for UE. For example, 2×2 DL MIMO refers to MIMO DL communications using two base station antennas and two UE antennas.

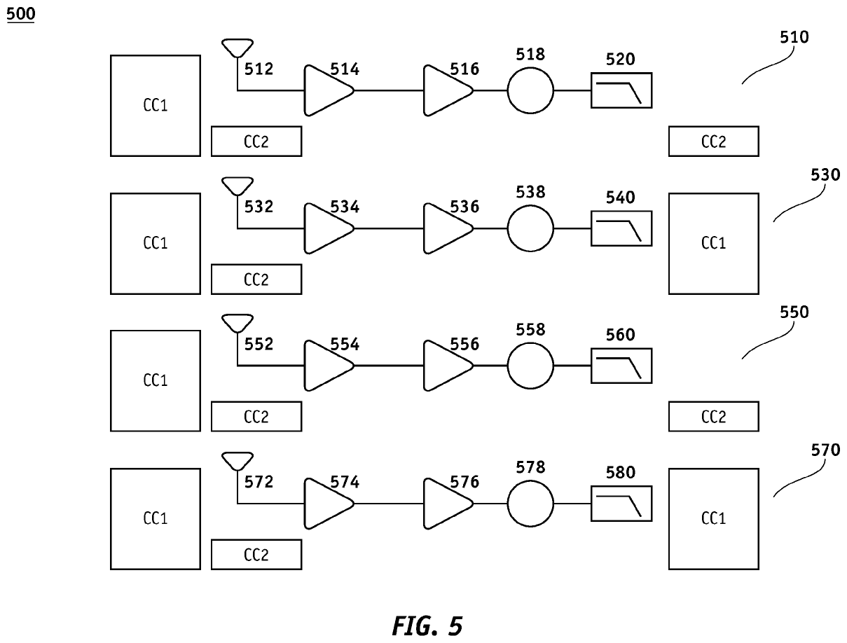

FIG. 5 is a schematic diagram illustrating a front-end of a receiver circuit 500 in a UE implementing a 2×2 MIMO communication. In some embodiments, the UE in FIG. 5 may be a type 2 UE and is configured to implement 2×2 MIMO communication using four antennas, in which the UE is only capable of receiving 2RX layers per CC. Antenna 512 and antenna 552 may communicate with a base station (e.g., gNB 306 in FIG. 3) to receive DL signals including DL CC2 and antenna 532 and antenna 572 may communicate with another base station (e.g., eNB 304 in FIG. 3) to receive DL signals including DL CC1.

Referring to FIG. 5, there are four independent signal chains (510, 530, 550, and 570) each having independent AGC. In the signal chain 510, an antenna 512 may be coupled to a low-noise amplifier (LNA) 514 that is configured to receive and amplify a radio frequency (RF) signal from antenna 512. The LNA 514 may be coupled to another amplifier (e.g., a variable gain amplifier (VGA)) 516, a mixer 518, and a filter 520. The signal chain 510 has an AGC (not shown) that controls the gain of the LNA 514 and the VGA 516. The mixer 518 may down convert the RF signal into intermediate frequency signal and digitally sample the signal to generate an in-phase signal and a quadrature phase signal that is approximately 90 degrees out of phase with the in-phase signal. The filter 520 may be configured to pass signals in a reception band and block signals in the remaining bands. The signal chain 510 may also include additional well-known components of a receiver circuit such as an analog-to-digital converter (ADC; not shown) that converts the amplified signal into a digital domain signal, a digital frequency rotator (not shown) that rotate the carrier to the respective communication carriers, etc. The descriptions of these additional components are omitted here. The signal chain 510 processes DL CC2.

The signal chain 530 includes an antenna 532, an LNA 534, an amplifier 536, a mixer 538, a filter 540, and has its own AGC (not shown). The signal chain 530 processes DL CC1. The signal chain 550 includes an antenna 552, an LNA 554, an amplifier 556, a mixer 558, a filter 560, and has its own AGC (not shown). The signal chain 550 transmits DL CC2. The signal chain 570 includes an antenna 572, an LNA 574, an amplifier 576, a mixer 578, a filter 580, and has its own AGC (not shown). The signal chain 570 processes DL CC1.

As shown above, by using four independent signal chains each having independent AGC, the 2×2 MIMO communication could be implemented in a type 2 UE. However, such a scheme may not work when the MIMO order increases, for example, to 4×4 MIMO, as discussed below. For comparison, the 4×4 MIMO implementation in type 1 UE is discussed first.

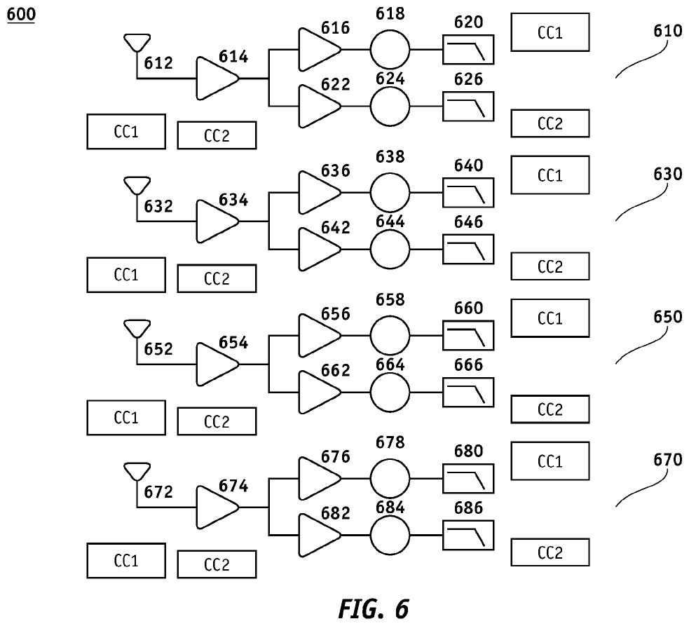

FIG. 6 is a schematic diagram illustrating a front-end of a receiver circuit 600 in a UE implementing a 4×4 MIMO communication. In some embodiments, the UE in FIG. 6 is a type 1 UE and may implement a 4×4 DL MIMO communication. A 4×4 DL MIMO refers to MIMO DL communications using four base station antennas and four UE antennas. Referring to FIG. 6, each of the antennas 612, 632, 652, and 672 may communicate with each of two base stations (e.g., the eNB 104 and the gNB 106 in FIG. 1) to receive DL CC1 and DL CC2. Thus, there are four signal chain groups (610, 630, 650, and 670). Each of the amplifiers (e.g., LNAs) 614, 634, 654, 674 may split the RF signal received from the corresponding antenna into two signal chains. Each signal chain may also include other components, e.g., amplifiers (616, 622, 636, 642, 656, 662, 676, 682), mixers (618, 624, 638, 644, 658, 664, 678, 684), and filters (620, 626, 640, 646, 660, 666, 680, 686). The functions of these components are similar to that of the corresponding components of FIG. 5, and for simplicity, the descriptions of these components are omitted. In a type 1 UE, since the propagation delay between DL CC1 and DL CC2 less than a length of a CP, each of the four signal chain groups 610, 630, 650, and 670 can have one AGC that controls corresponding one of the LNAs 614, 634, 654, and 674.

However, when the UE in FIG. 6 is a type 2 UE, the 4×4 DL MIMO communication may be difficult to implement because the received RF signals are amplified and split at the LNAs 614, 634, 654, and 674, and the LNAs 614, 634, 654, and 674 are controlled by the AGC. Also, due to the large propagation delay between DL CC1 and DL CC2, the phase transient cannot be confined within a CP. At least some embodiments of this disclosure provide solutions to the issue in implementing 4×4 DL MIMO communication in a type 2 UE by providing phase compensation in each signal chain groups 610, 630, 650, and 670, so that each signal chain group can only use one AGC, as discussed below.

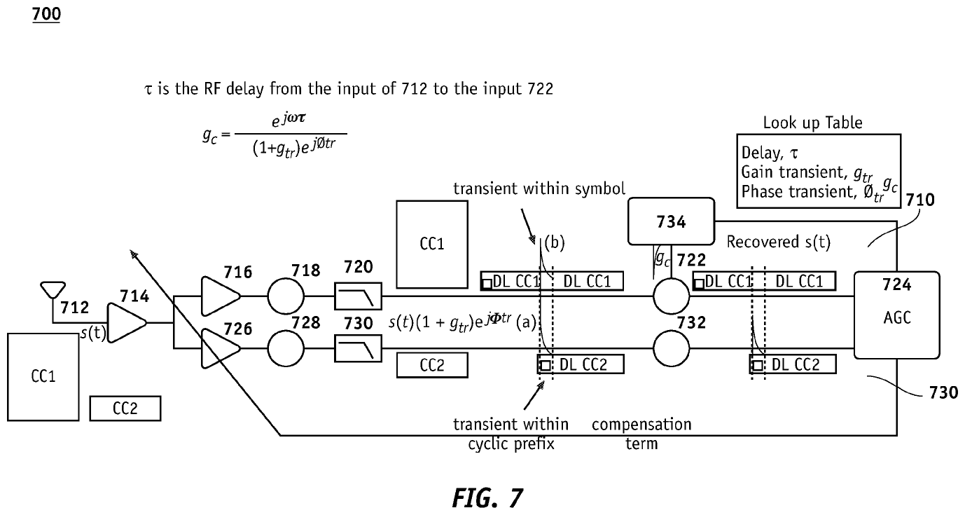

FIG. 7 is a schematic diagram illustrating phase compensation in a front-end of a receiver circuit 700 of a UE, consistent with some embodiments of the present disclosure. In some embodiments, the UE is a type 2 UE implementing a 4×4 MIMO communication with two base stations (e.g., an eNB and a gNB). The UE may include four receiver circuits each of which is similar to the receiver circuit 700. Referring to FIG. 7, the receiver circuit 700 is coupled to an antenna 712 to receive an RF signal from the base stations. The receiver circuit 700 includes an amplifier (e.g., an LNA) 714 that is configured to amplify the received RF signal and split the signal into two signal chains 710 and 730. The signal chain 710 includes a VGA 716, a mixer 718, a filter 710, and a digital complex rotator 722. The signal chain 730 includes a VGA 726, a mixer 728, a filter 730, and a digital complex rotator 732. Both signal chains 710 and 730 are connected to an AGC 724 that is configured to control the gain of the LNA 714 and the VGAs 716 and 726. Each signal chain may also include additional well-known components of a receiver circuit such as an ADC (not shown) that converts the amplified signal into a digital domain signal, a digital frequency rotator (not shown) that rotates the carrier to the respective communication carriers, etc. The descriptions of these additional components are omitted here. Each signal chain receives the split RF signal, amplifies the RF signal, down-mixes the signal to an intermediate frequency signal, converts the signal to a digital domain signal, and digitally samples the signal to generate an in-phase signal and a quadrature phase signal that is approximately 90 degrees out of phase with the in-phase signal. The signal chain 710 processes a DL CC1 and the signal chain 730 processes a DL CC2.

As shown in FIG. 7, there is a propagation delay between the DL CC1 and the DL CC2. Such a propagation delay between the DL CC1 and the DL CC2 is schematically shown in FIG. 4B. For the DL CC2, the phase transient (indicated using a burst (a) in the figure) due to the change of gain state is confined within a CP and thus negligible. However, in DL CC1, the phase transient occurs in the middle of the symbol (indicated using a burst (b) in the figure) and the effect of the phase transient may be significant. This phase transient can be compensated in digital domain using the digital complex rotator. For example, as shown in FIG. 7, the pre-transient signal (the signal before passing the LNA 714) can be expressed as S(t), the post-transient signal (the signal at which a phase transient occurred) can be expressed as S(t)(1+gₜᵣ)e^{jØ}^{ₜᵣ}, and the post-transient pre-compensation signal (the signal at which a phase transient occurred but the transient is not compensated) can be expressed as S(t)(1+gₜᵣ)e^{jØ}^{ₜᵣ}e^{-jωτ}, where τ is an RF delay from the input at the antenna 712 to the input at the digital complex rotator 722, gₜᵣ, is a gain transient, Øₜᵣ is a phase transient. The phase transient can be compensated by multiplying the post-transient pre-compensation signal by a compensation term

$${g}_{c} = \frac{{e}^{j ωτ}}{( 1 + {g}_{tr} ) {e}^{j {ϕ}_{tr}}}$$

using the digital complex rotator. The compensation term g_{c} is determined once the RF delay τ, the gain transient gₜᵣ, and the phase transient Øₜᵣ are known.

In some embodiments, the RF delay τ, the gain transient gₜᵣ, and the phase transient Øₜᵣ are obtained from the lookup table 734 so that the compensation term g_{c}, can be determined. The lookup table 734 takes advantage of the fact that the gain state phases can be determined beforehand. Through testing and characterizing, the gain state phases can be determined beforehand and pre-recorded in the lookup table. In some embodiments, the lookup table 734 may be stored in a storage device of the UE. In some embodiments, the lookup table 734 may be maintained in a firmware or in software. The lookup table may be updated based on later testing or performance requirements.

The phase compensation may be performed based on a triggering signal provided by the AGC 724. The AGC 724 may trigger the phase compensation whenever the gain state of the amplifier changes. In some embodiments, the AGC 724 may trigger the phase compensation by controlling the provision time of the lookup table 734.

As shown in FIG. 7, the signal output from the digital complex rotator 722 is a compensated signal (recovered to pre-transient signal S(t)) in which the phase transient is eliminated. In this way, the phase compensated signal may be demodulated without DL error vector magnitude degradation. By compensating gain state phase in digital domain, 4×4 MIMO communication can be easily implemented in a type 2 UE having dual connectivity with non-collocated base stations.

The above-described embodiments are directed to a technique for phase compensation of DL signals in a type 2 UE having dual connectivity with an eNB and a gNB. However, the application of the technique is not so limited. The disclosed phase compensation technique may be used in any system implementing multicarrier communication. Also, the base stations (the eNB, gNB) for the dual connectivity are not so limited. The base stations can be any types of base stations currently exist or future developed. For example, in some embodiments, instead of connecting with an eNB and a gNB, the UE may have dual connection with two 4G base stations or two 5G base stations.

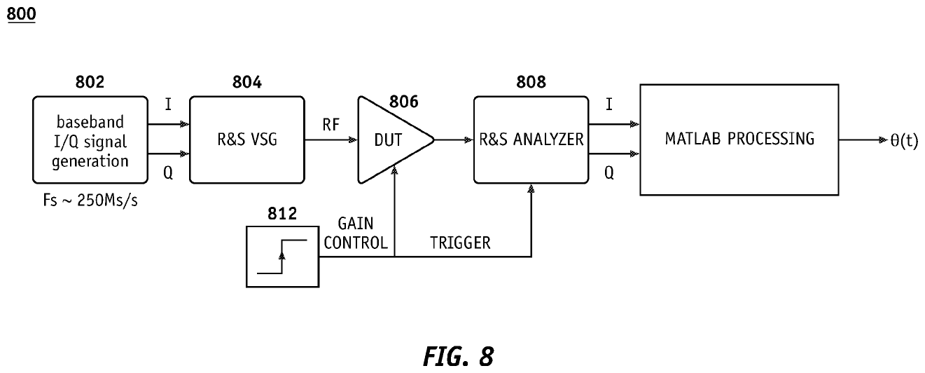

FIG. 8 is a schematic diagram illustrating an exemplary phase compensation measurement platform 800, consistent with some embodiments of the present disclosure. As a first step (802), the phase compensation measurement platform 800 generates a baseband in-phase signal (I) and a quadrature phase signal (Q). The baseband I/Q signal may be generated using MATLAB. The generated signal may be expressed mathematically as e^{j(ω}^{_{C}}^{+ω}^{_{BB}}^{)t+θ(t)}. In some embodiments, the sampling rate of the signal may be 250 Ms/s.

The phase compensation measurement platform 800 includes a vector signal generator (VSG) 804 configured to up-convert the baseband I/Q signals into an RF signal and modulate the RF signal. In some embodiments, the VSG 804 may be Rohde & Schwarz (R&S) VSG.

The phase compensation measurement platform 800 includes a device-under-test (DUT) 806 that includes a power amplifier. The power amplifier may be an LNA. The power amplifier is configured to amplify the RF signal received from R&S VSG and provide an RF output. The gain of the power amplifier may be controlled by an AGC 812 that is connected to the DUT 806.

The phase compensation measurement platform 800 includes a vector signal analyzer 808 configured to demodulate the RF signal provided by the DUT 806. In some embodiments, the vector signal analyzer is an R&S vector signal analyzer. The vector signal analyzer may output the I/Q signal based on a trigger signal provided by the AGC 812. For example, the AGC 812 may provide the trigger signal whenever the amplifier gain state changes. The demodulated I/Q signal output from the vector signal analyzer 808 then processed using MATLAB.

The processing of demodulated I/Q signal using MATLAB may include a step of collecting RF envelope of the I/Q signal at a trigger time decided by the trigger signal from the AGC 812. Collecting RF envelope may be performed within a suitable time window determined by the AGC 812. The MATLAB processing also includes steps of de-rotating the I/Q samples to compensate phase transient; transforming Cartesian to complex; and obtaining the transient values and the transient durations at the time the phase compensation is completed.

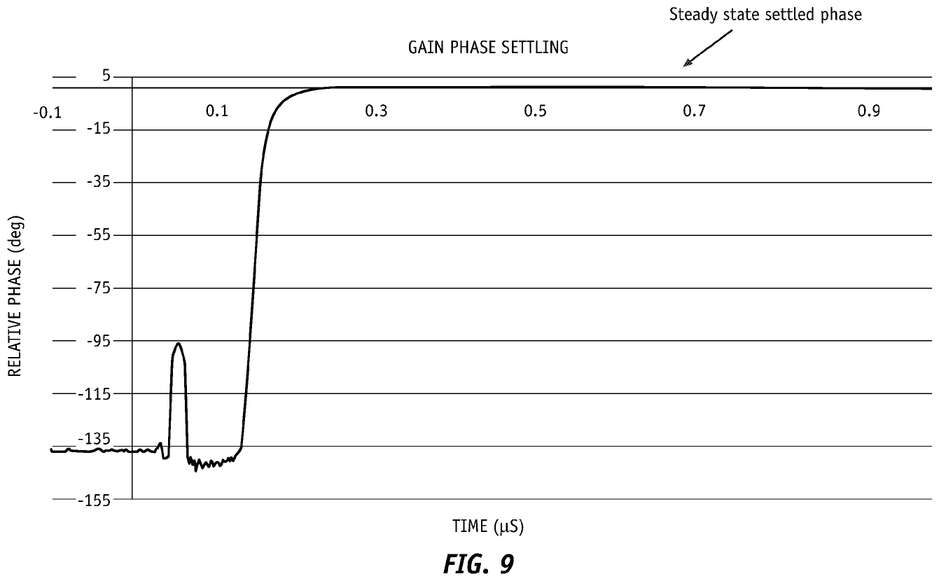

FIG. 9 is a plot illustrating measured settling of the gain phase of a received signal, consistent with some embodiments of the present disclosure. Referring to FIG. 9, after a very brief fluctuation, the phase settled well to a final value with +5 degree of error to arrive at a steady state phase. The settling of the phase is exponential in nature. The time required for settling the phase is less than 1 μs. FIG. 9 shows a relative phase over time, but the absolute phase transient can also be obtained by subtracting a steady state phase from the graph shown in FIG. 9.

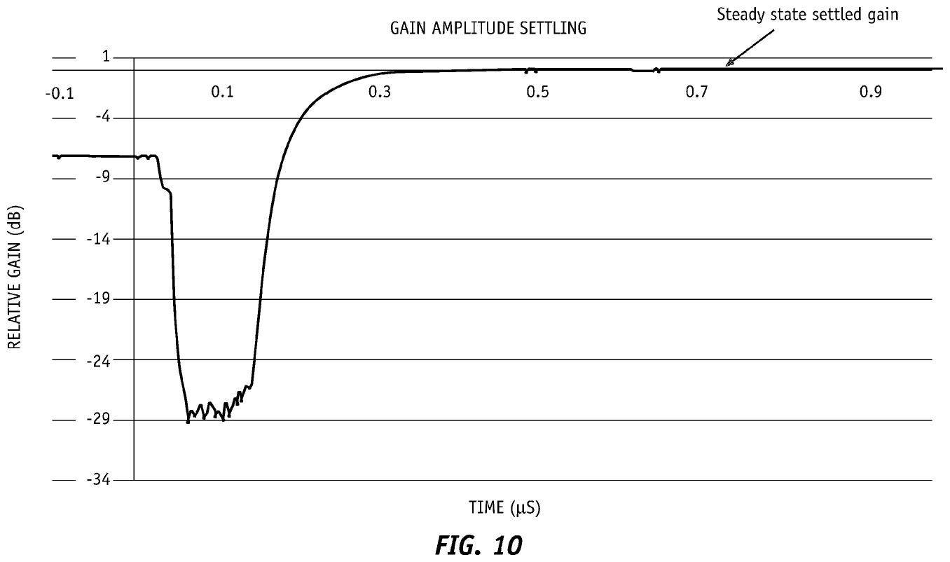

FIG. 10 is a plot illustrating measured settling of the gain amplitude of a received signal, consistent with some embodiments of the present disclosure. Referring to FIG. 10, after a very brief fluctuation, the gain amplitude settled well to a final value with +0.5 dB of error to arrive at a steady state gain state. The settling of the gain amplitude is exponential in nature. The time required for settling the gain amplitude is less than 1 μs. FIG. 10 shows a relative gain over time, but the absolute gain transient may be obtained by subtracting a steady state gain from the graph shown in FIG. 10.

The error vector magnitude (EVM) glitch due to gain and phase transient of the system is simulated. The transient can be modeled using a formula Transient=(1+gₜᵣ)e^{jØ}^{ₜᵣ}, where gₜᵣ, Øₜᵣ, are decaying exponential functions.

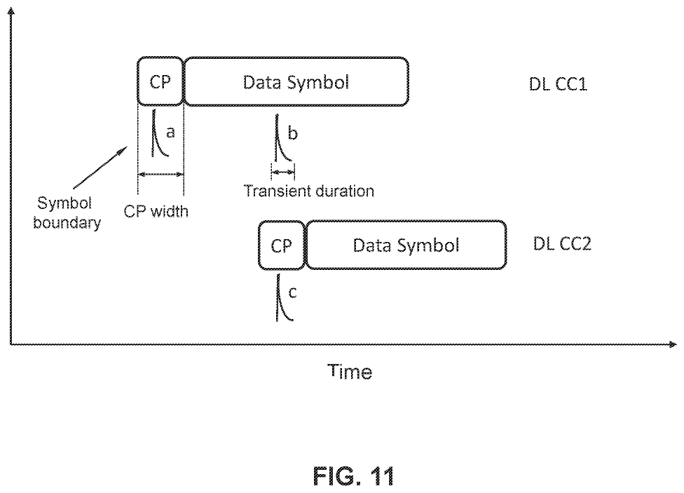

FIG. 11 is a schematic drawing illustrating the parameters used in the simulation, consistent with some embodiments of the present disclosure. Referring to FIG. 11, the system models the transient as a function of the three parameters: (1) a peak transient level, (2) a transient duration, and (3) a position of transient relative to the symbol boundary. The transient a and c occur inside of the CP and transient b occurs outside of the CP. If a transient occurs outside of the CP (e.g., transient b), the transient has higher level of degrades to EVM. For example, the transient b in FIG. 11 may have the peak transient level. On the other hand, if a transient occurs inside of the CP (e.g., transients a, c), degradation of the EVM may be neglected. The transient duration may be measured relative to a CP width. A larger duration may degrade EVM. If the position of the transient is outside the CP (e.g., transient b), the EVM may be degraded. On the other hand, if the position of the transient is within the CP (transient a), degradation of the EVM may be neglected.

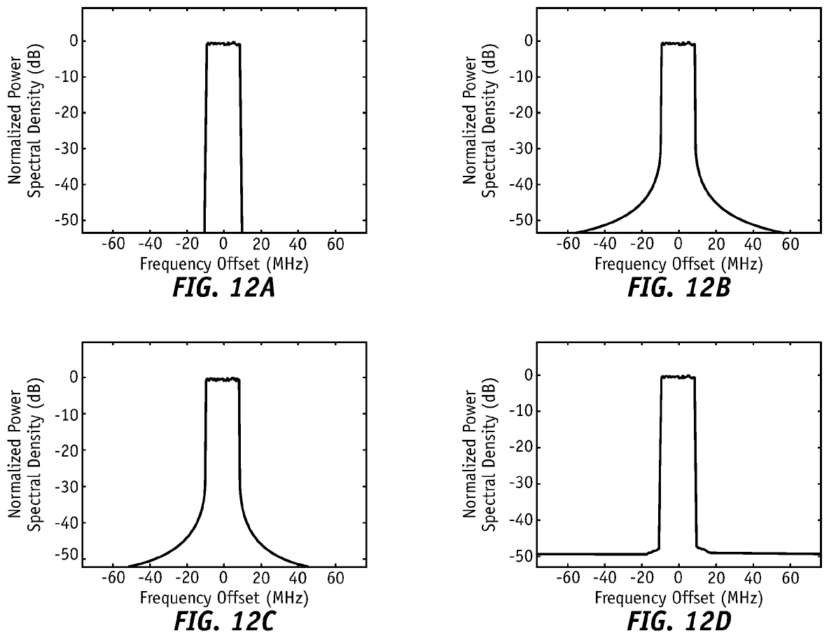

FIG. 12A is a plot illustrating a simulated frequency-domain normalized power spectral density of an input signal; FIG. 12B is a plot illustrating a simulated frequency-domain normalized power spectral density of a signal having transient in the CP of the symbol; FIG. 12C is a plot illustrating a simulated frequency-domain normalized power spectral density of a signal having transient in the middle of the symbol; and FIG. 12D is a plot illustrating a simulated frequency-domain normalized power spectral density of the signal having transient compensated, consistent with some embodiments of the present disclosure.

Referring to FIG. 12A, the input signal has a bandwidth of 20 MHz and a frequency offset of 0 MHz. When transient occurs within the CP (FIG. 12B) or in the middle of the symbol (FIG. 12C), the normalized power spectral density shows dispersion along frequency offset axis. When the transient was compensated by the above-described method, the normalized power spectral density of the compensated signal (FIG. 12D) is almost recovered to the original state (FIG. 12A). In all cases (FIG. 12B-FIG. 12D), the phase transient was 20 degrees, and the gain transient was 10 dB. Referring to FIG. 12D, the transient was compensated with 0.5 dB gain error and 5 degrees phase error,

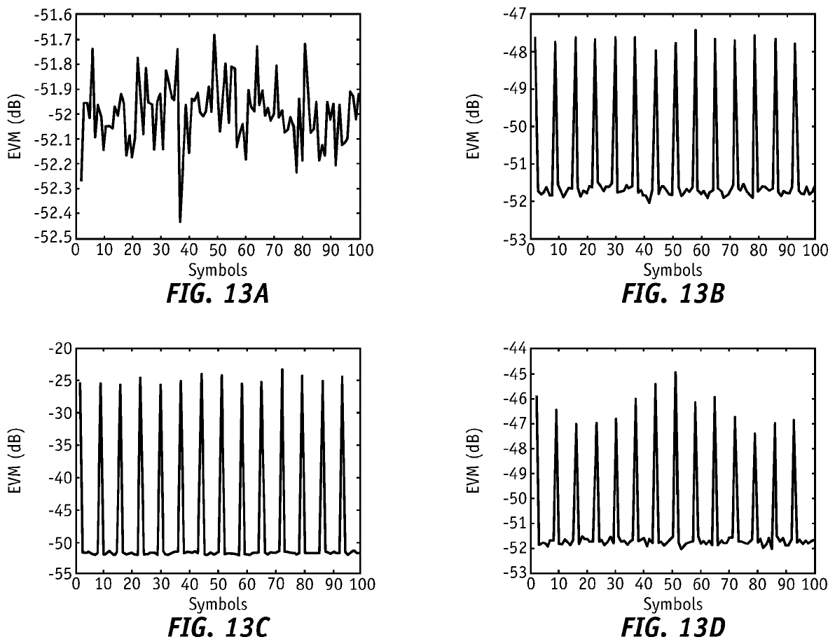

FIG. 13A is a plot illustrating a simulated symbol EVM of an input signal; FIG. 13B is a plot illustrating a simulated symbol EVM of the signal having transient in the CP of the symbol; FIG. 13C is a plot illustrating a simulated symbol EVM of the signal having transient in the middle of the symbol; and FIG. 13D is a plot illustrating a simulated symbol EVM of the signal having transient compensated, consistent with some embodiments of the present disclosure.

Referring to FIG. 13A, the input signal shows a minimum EVM. When transient occurs in the CP (FIG. 13B), the transient causes a burst (around 4 dB) at the beginning of each symbol and thus degradation of the symbol EVM occurs. When transient occurs in the middle of the symbol (FIG. 13C), the larger burst (around 25 dB) occurs at the beginning of each symbol and thus the degradation of the symbol EVM is significant. When the transient was compensated by the above-described method, the burst reduced significantly (around 5-7 dB) and thus the degradation of the symbol EVM reduced. In all cases (FIG. 13B-FIG. 13D), the phase transient was 20 degrees, and the gain transient was 10 dB. Referring to FIG. 13D, the transient was compensated with 0.5 dB gain error and 5 degrees phase error.

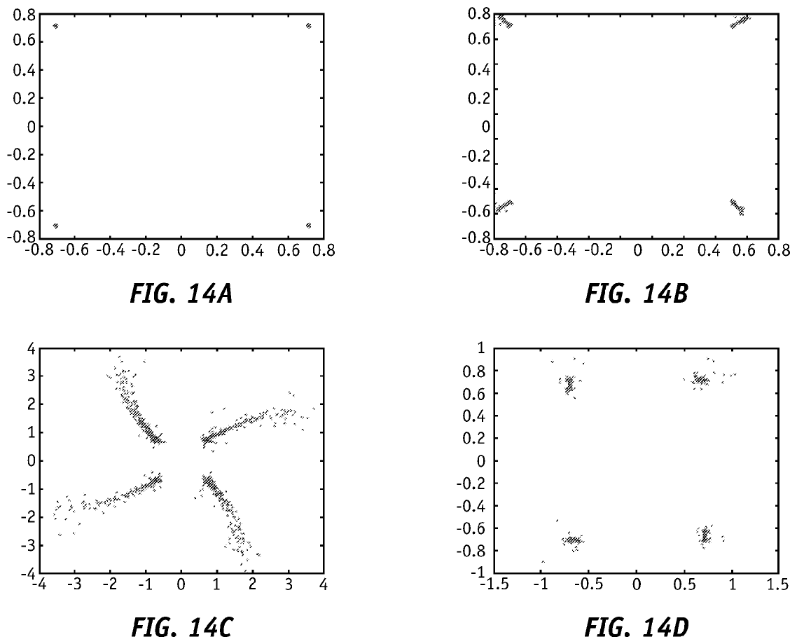

FIG. 14A is a diagram illustrating constellation of an input signal; FIG. 14B is a diagram illustrating constellation of the signal having transient in the CP of the symbol; FIG. 14C is a diagram illustrating constellation of the signal having transient in the middle of the symbol; and FIG. 14D is a diagram illustrating constellation of the signal having transient compensated, consistent with some embodiments of the present disclosure.

A constellation diagram is based on modulation, such as Quadrature Phase Shift Keying (QPSK) modulation. A QPSK modulation encodes the in-phase and quadrature bits into four different symbol states that are represented by a two-bit symbol and associated phase. The phase for each state is 90° out of phase with adjacent states. These states can be represented on the constellation diagram by the four points at the corners. Ideally, the magnitude of these points is unity.

Referring to FIG. 14A, the measured symbol positions fall on one of the four constellation points, i.e., at the ideal constellation positions. When transient occurs in the CP (FIG. 14B), the measured constellation positions fall on points that are not exactly at the four ideal constellation points and deviated from the ideal positions, but deviation is not significant. When transient occurs in the middle of the symbol (FIG. 14C), the measured constellation positions significantly deviated from the ideal positions. When the transient was compensated by the above-described method (FIG. 14D), constellation positions does not show large deviation from the ideal positions. In all cases (FIG. 14B-FIG. 14D), the phase transient was 20 degrees, and the gain transient was 10 dB. Referring to FIG. 14D, the transient was compensated with 0.5 dB gain error and 5 degrees phase error.

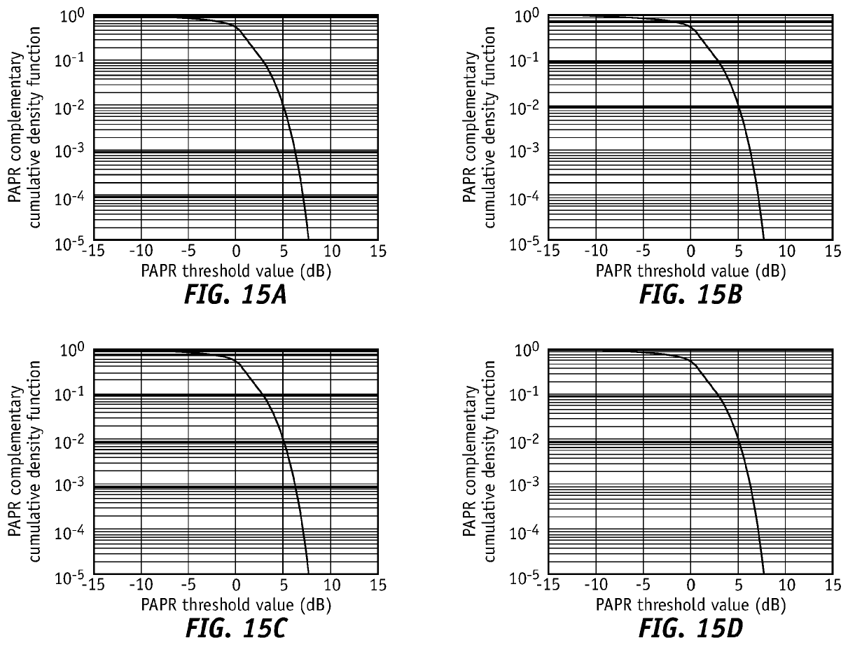

FIG. 15A is a plot illustrating a simulated complimentary cumulative density function (CCDF) of an input signal; FIG. 15B is a plot illustrating a simulated CCDF of the signal having transient in the CP of the symbol; FIG. 15C is a plot illustrating a simulated CCDF of the signal having transient in the middle of the symbol; and FIG. 15D is a plot illustrating a simulated CCDF of the signal having transient compensated, consistent with some embodiments of the present disclosure.

When the signals on subcarriers are in-phase, the superposition of them will generate a relatively large peak power, which will cause a large ratio of signal peak power to signal average power. The ratio is called Peak-to-Average Power Ratio (PAPR). The PAPR performance of a signal (or a system) is generally characterized by the Cumulative Density Function (CDF) of the PAPR. The CCDF of the PAPR represents the probability of the power of the time-domain signal of a data block exceeding a certain threshold value. As shown in the figures, the input signal (FIG. 15A), the signal having transient in the CP of the symbol (FIG. 15B), the signal having transient in the middle of the symbol (FIG. 15C), and the signal having transient compensated (FIG. 15D) have similar CCDF waveforms, indicating similar PAPR performances.

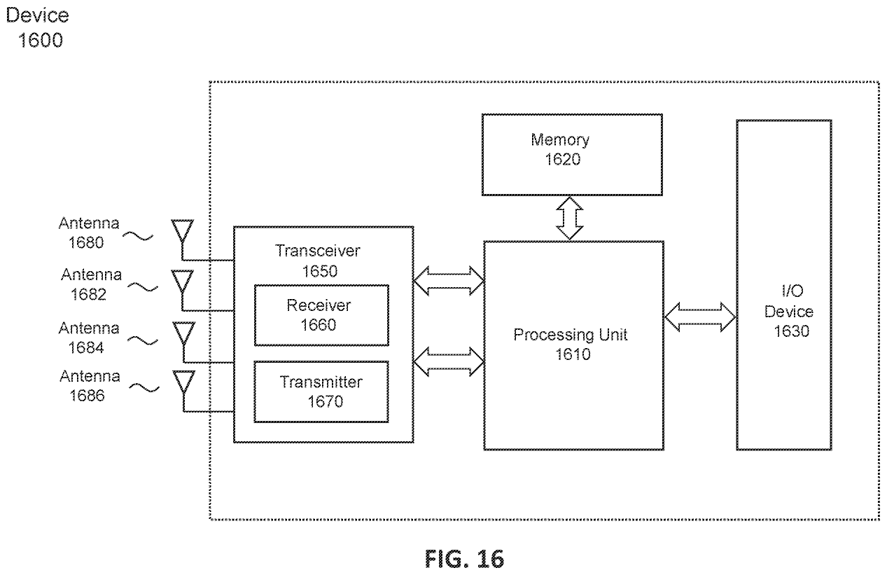

FIG. 16 is a block diagram illustrating an exemplary device 1600, consistent with some embodiments of the present disclosure. Referring to FIG. 16, device 1600 may take any form, including but not limited to, a wireless terminal including a mobile phone, a wireless handheld device, a wireless personal device, a laptop computer, a Global Positioning System, or any other forms. Device 1600 includes an array of antennas 1680, 1682, 1684, and 1686, a transceiver 1650 coupled to the antenna array, a processor 1610, a memory 1620, a local clock (not shown), and an input/output (I/O) device 1630. The transceiver 1650 further includes a receiver 1660 and a transmitter 1670. FIG. 16 shows an antenna array including four antennas, but the number of antennas is not so limited. The device 1600 may include any number of antennas.

Receiver 1660 is coupled to the antennas 1680, 1682, 1684, and 1686 and configured to receive DL RF signals from one or more base stations or sidelink signals from other devices via the antennas. Transmitter 1670 is also coupled to the antennas 1680, 1682, 1684, and 1686 and configured to transmit uplink RF signals to one or more base stations or sidelink signals to other external devices.

In some embodiments, device 1600 is a UE, such as the UE 302 in FIG. 3 that has dual connectivity with an eNB and a gNB that are non-collocated. The device 1600 may implement a 4×4 MIMO communication. The receiver 1660 may include four receiver circuits (not shown) each of which is similar to the receiver circuit 700 as shown in FIG. 7. Each of the four receiver circuits may be coupled to a corresponding antenna and receive an RF signal. The received signal may be amplified and split into two signal chains by an amplifier, such as the LNA 714 of FIG. 7. Each signal chain amplifies the RF signal by a VGA, such as the VGAs 716 and 726 of FIG. 7, down-mixes the signal to an intermediate frequency signal using a mixer, such as the mixer 718 and 728 of FIG. 7, and digitally samples the signal to generate an in-phase signal and a quadrature phase signal. Each signal chain also includes a digital complex rotator, such as the digital complex rotators 722 and 732, that performs phase compensation using a lookup table, such as the lookup table 734. The lookup table may include data needed for the phase compensation, such as components carrier information, gain transient values, phase transient values, and RF delay values. The data in the lookup table may be obtained in advance by phase compensation measurements and stored in memory 1620 of the device 1600. In some embodiments, the lookup table may be maintained in a firmware or in software.

The processor 1610 may include one or more dedicated processing units, application-specific integrated circuits (ASICs), field-programmable gate arrays (FPGAs), or various other types of processors or processing units. The processor 1610 may receive from the receiver 1660, the processed signal and further process the signal to obtain information sent from the base stations or other external devices. The processor 1610 may be configured to communicate with the I/O device 1630, and the memory 1620.

In some embodiments, the receiver 1660 may include a built-in processor (not shown) that performs all or part of the function of the processor 1610. In an embodiment, the built-in processor of the receiver 1660 may be a front-end processor that controls signal processing in the receiver 1660, and the processor 1610 may be a back-end processor that performs further computations based on the signal processing in the receiver 1660. In some embodiments, the processor 1610 may assign a computation task to a remote computer (not shown) so that the remote computer performs a portion of the computations and transmits the computation results to the processor 1610.

The memory 1620 may be any type of computer-readable storage medium including volatile or non-volatile memory devices, or a combination thereof. The memory 1620 may store the lookup table. The memory 1620 may store information related to the identities of the device 1600, the base stations, other external devices, the component carriers received by the antenna array. The memory 1620 may also store post-processing signals. The memory 1620 may also store the phase compensation measurements and the quality metrics associated with the measurements. The memory 1620 may also store computer-readable instructions, mathematical models, and algorithms that are used in signal processing in the receiver 1660 and computations in the processor 1610. The memory 1620 may further store computer-readable instructions for execution by the processor 1610 to operate the device 1600.

The I/O device 1630 may be used to communicate a result of signal processing to a user or another device. The I/O device 1630 may include a user interface including a display and an input device to transmit a user command to the processor 1610. The display may be configured to display data received by the device 1600, the data stored at memory 1620, etc. The display may include, but is not limited to, a liquid crystal display (LCD), a light-emitting diode (LED), a gas plasma display, a touch screen, a cathode ray tube (CRT), or other image projection devices for displaying information to a user. The input device may be any type of computer hardware equipment used to receive data and control signals from a user. The input device may include, but is not limited to, a touchscreen monitor, a keyboard, a mouse, a scanner, a digital camera, a joystick, a trackball, cursor direction keys, or audio/video commanders, etc. The I/O device 1630 may further include a machine interface, such as an electrical bus connection or a wireless communications link.

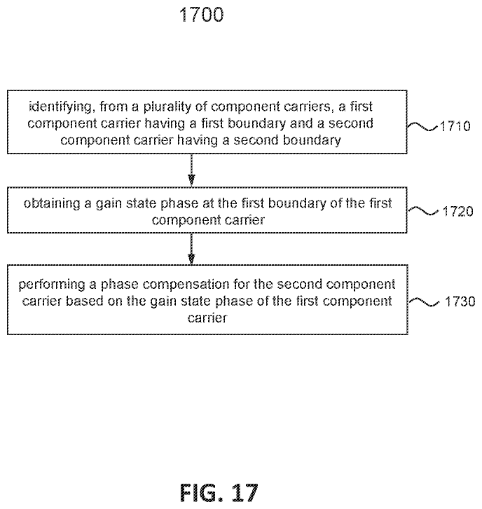

FIG. 17 is a flow chart illustrating a method 1700 for phase compensation in multicarrier communication, consistent with some embodiments of the present disclosure. The method may be performed by a device, such as device 1600 of FIG. 16. Referring to FIG. 17, method 1700 includes a step 1710 of identifying, from a plurality of component carriers, a first component carrier having a first boundary and a second component carrier having a second boundary. For example, the device 1600 may be a type 2 UE that communicates with two base stations and receives DL CC1 and DL CC2 as shown in and FIG. 4A and FIG. 4B. As shown in FIG. 4B, DL CC 1 has a boundary at t1 and the DL CC2 has a boundary at t2. The t1 and t2 may be the arrival times of the DL CC1 and the DL CC2 at the device 1600.

Method 1700 further includes a step 1720 of obtaining a gain state phase at the first boundary of the first component carrier. For example, the gain state phase of the first component carrier may be obtained from a lookup table, such as the lookup table 734 of FIG. 7. The lookup table may provide an RF delay τ, a gain transient gₜᵣ, and a phase transient Øₜᵣ so that a compensation term g_{c} can be determined. The phase transient value and the gain transient value may be pre-determined using a measurement setup such as the measurement setup 800 of FIG. 8.

Method 1700 further includes a step 1730 of performing a phase compensation for the second component carrier based on the gain state phase of the first component carrier. The phase compensation may be performed in digital domain using a digital complex rotator by obtaining the gain state phase from the lookup table. Performing the phase compensation for the second component carrier may include de-rotating an OFDM symbol of the second component carrier corresponding to the first boundary of the first component carrier by multiplying the OFDM symbol by a compensation term g_{c}. In some embodiments, the compensation term can be determined using a formula

$${g}_{c} = \frac{{e}^{j ωτ}}{( 1 + {g}_{tr} ) {e}^{j {ϕ}_{tr}}} .$$

The first component carrier and the second component carrier may be two DL component carriers transmitted to the device 1600 from a first base station and a second base station. The first base station may be an eNB and the second base station may be a gNB, and the eNB and the gNB may be non-collocated. The disclosed method at least provides solutions to the problem of implementing 4×4 MIMO communication in a type 2 UE having dual connectivity with the eNB and gNB, by providing a method for compensating phase transient in the type 2 UE in digital domain.

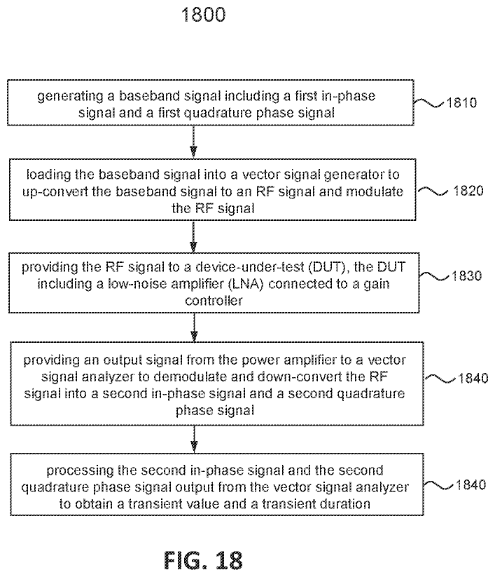

FIG. 18 is a flow chart illustrating a method 1800 for characterizing a phase transient in carrier components, consistent with some embodiments of the present disclosure. Method 1800 includes a step 1810 of generating a baseband signal including a first in-phase signal and a first quadrature phase signal. The baseband signal may be generated using a MATLAB processing.

Method 1800 further includes a step 1820 of loading the baseband signal into a VSG, such as an R&S VSG, to up-convert the baseband signal to an RF signal and modulate the RF signal.

Method 1800 further includes a step 1830 of providing the RF signal to a DUT. The DUT may include an LNA connected to an AGC and configured to amplify the RF signal received from the VSG.

Method 1800 further includes a step 1840 of providing an output signal from the power amplifier to a vector signal analyzer to demodulate and down-convert the RF signal into a second in-phase signal and a second quadrature phase signal.

Method 1800 further includes a step 1850 of processing the second in-phase signal and the second quadrature phase signal output from the vector signal analyzer. The processing of the second in-phase signal and the second quadrature phase signal may be performed using a MATLAB processing. The processing may include collecting an RF envelope based on a trigger signal received from the AGC; de-rotating the second in-phase signal and the second quadrature phase signal; transforming Cartesian to complex; and obtaining transient values and a transient duration based on the phase compensation result.

The computer-readable storage medium of the present disclosure may be a tangible device that can store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

It should be understood that the steps of the example methods set forth herein are not necessarily required to be performed in the order described, and the order of the steps of such methods should be understood to be merely example. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

As used in the present disclosure, the word “exemplary” is used herein to mean serving as an example, instance, or illustration. Any aspect or design described herein as “exemplary” is not necessarily to be construed as preferred or advantageous over other aspects or designs. Rather, use of the word is intended to present concepts in a concrete fashion.

As used in the present disclosure, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

1.-28. (canceled)

29. A method for phase compensation in multicarrier communication, comprising:
identifying, from a plurality of component carriers, a first component carrier having a first boundary and a second component carrier having a second boundary;
obtaining a gain state phase at the first boundary of the first component carrier; and
performing a phase compensation for the second component carrier based on the gain state phase of the first component carrier.

30. The method of claim 29, wherein the gain state phase of the first component carrier is obtained from a lookup table.

31. The method of claim 30, wherein the phase compensation is performed using a digital complex rotator by obtaining the gain state phase from the lookup table.

32. The method of claim 29, performing the phase compensation for the second component carrier comprises de-rotating an OFDM symbol of the second component carrier corresponding to the first boundary of the first component carrier by multiplying the OFDM symbol by a compensation term
$${g}_{c} = \frac{{e}^{j ωτ}}{( 1 + {g}_{tr} ) {e}^{j {ϕ}_{tr}}} ,$$
where τ denotes an RF delay from a pre-transient signal to a post-transient pre-compensation signal of the second component carrier, gₜᵣ denotes a gain transient value, and Øₜᵣ denotes a phase transient value.

33. The method of claim 32, wherein the pre-transient signal is expressed as S(t), a post-transient signal is expressed as S(t)(1+gₜᵣ)e^{jØ}^{ₜᵣ}, and the post-transient pre-compensation signal is expressed as S(t)(1+gₜᵣ)e^{jØ}^{ₜᵣ}e^{-jωτ}.

34. The method of claim 32, wherein the phase transient value is determined by a method comprising:
generating a baseband signal including a first in-phase signal and a first quadrature phase signal;
loading the baseband signal into a vector signal generator to up-convert the baseband signal to an RF signal and modulate the RF signal;
providing the RF signal to a device-under-test (DUT), the DUT including a low-noise amplifier (LNA) connected to a gain controller;
providing an output signal from the LNA to a vector signal analyzer to demodulate and down-convert the RF signal into a second in-phase signal and a second quadrature phase signal; and
processing the second in-phase signal and the second quadrature phase signal output from the vector signal analyzer.

35. The method of claim 34, wherein processing the second in-phase signal and the second quadrature phase signal comprises:
collecting an RF envelope based on a trigger signal received from the gain controller;
de-rotating the second in-phase signal and the second quadrature phase signal;
transforming Cartesian to complex; and
obtaining the phase transient value and a phase transient duration.

36. The method of claim 35, wherein the trigger signal is generated at a time when a gain state of the LNA is changed.

37. A mobile device for wireless communication, comprising:
at least one antenna;
a processor; and
a memory storing instructions, when executed by the processor, cause the mobile device to:
receive a signal comprising a first component carrier and a second component carrier, the first component carrier including a first boundary and the second component carrier including a second boundary;
obtain a gain state phase at the first boundary of the first component carrier; and
perform a phase compensation for the second component carrier based on the gain state phase of the first component carrier.

38. The mobile device of claim 37, wherein the gain state phase of the first component carrier is obtained from a lookup table stored in the mobile device.

39. The mobile device of claim 38, further comprising a digital complex rotator configured to perform the phase compensation using the gain state phase of the first component carrier obtained from the lookup table.

40. The mobile device of claim 37, performing the phase compensation for the second component carrier comprises de-rotating an OFDM symbol of the second component carrier corresponding to the first boundary of the first component carrier by multiplying the OFDM symbol by a compensation term
$${g}_{c} = \frac{{e}^{j ωτ}}{( 1 + {g}_{tr} ) {e}^{j {ϕ}_{tr}}} ,$$
where τ denotes an RF delay from a pre-transient signal to a post-transient pre-compensation signal of the second component carrier, gₜᵣ denotes a gain transient value, and Øₜᵣ denotes a phase transient value.

41. The mobile device of claim 40, wherein the pre-transient signal is expressed as S(t), a post-transient signal is expressed as S(t)(1+gₜᵣ)e^{jØ}^{ₜᵣ}, and the post-transient pre-compensation signal is expressed as S(t)(1+gₜᵣ)e^{jØ}^{ₜᵣ}e^{-jωτ}.

42. The mobile device of claim 37, wherein the mobile device is configured to be connected to a first base station and a second base station at the same time and the first component carrier and the second component carrier are two downlink component carriers transmitted to the mobile device.

43. The mobile device of claim 42, wherein the first base station is an eNB and the second base station is a gNB, the eNB and the gNB being non-collocated.

44. The mobile device of claim 43, wherein the mobile device further includes at least four antennas configured to communicate with the eNB and the gNB using 4×4 multiple-input and multiple-output (MIMO) communication, and the phase compensation is performed for each signal path connected to each of the four antennas.

45. The mobile device of claim 37, wherein a same automatic gain controller (AGC) is used for processing the first component carrier and the second component carrier.

46. The mobile device of claim 41, wherein the phase transient value is determined by a method comprising:
generating a baseband signal including a first in-phase signal and a first quadrature phase signal;
loading the baseband signal into a vector signal generator to up-convert the baseband signal to an RF signal and modulate the RF signal;
providing the RF signal to a device-under-test (DUT), the DUT including a low-noise amplifier (LNA) connected to a gain controller;
providing an output signal from the LNA to a vector signal analyzer to demodulate and down-convert the RF signal into a second in-phase signal and a second quadrature phase signal; and
processing the second in-phase signal and the second quadrature phase signal output from the vector signal analyzer.

47. The mobile device of claim 46, wherein processing the second in-phase signal and the second quadrature phase signal comprises:
collecting an RF envelope based on a trigger signal received from the gain controller;
de-rotating the second in-phase signal and the second quadrature phase signal;
transforming Cartesian to complex; and
obtaining a phase transient value and a phase transient duration.

48. The mobile device of claim 47, wherein the trigger signal is generated at a time when a gain state of the LNA is changed.

49. A non-transitory computer readable medium storing instructions that, when executed by a processor, perform a method comprising:
identifying, from a plurality of component carriers, a first component carrier having a first boundary and a second component carrier having a second boundary;
obtaining a gain state phase at the first boundary of the first component carrier; and
performing a phase compensation for the second component carrier based on the gain state phase of the first component carrier.
